(19) United States
(12) Patent Application Publication
(10) Pub. No.: US 2025/0118830 A1
(43) Pub. Date: Apr. 10, 2025

(54) BATTERY MODULE COOLING STRUCTURE

(71) Applicants: HYUNDAI MOTOR COMPANY, SEOUL (KR); KIA CORPORATION, SEOUL (KR)

(72) Inventors: Hyunchang Kang, Hwaseong-si (KR); Jiwoong Jung, Hwaseong-si (KR); Junyoung Kang, Hwaseong-si (KR)

(73) Assignees: HYUNDAI MOTOR COMPANY, SEOUL (KR); KIA CORPORATION, SEOUL (KR)

(21) Appl. No.: 18/910,762

(22) Filed: Oct. 9, 2024

(30) Foreign Application Priority Data
Oct. 10, 2023 (KR) 10-2023-0134256

(51) Int. Cl. H01M 10/6568; H01M 10/613; H01M 50/242

(52) U.S. Cl. CPC H01M 10/6568; H01M 10/613; H01M 50/242

(57) ABSTRACT

A battery module cooling structure for a battery module configured by assembling a plurality of battery cells, the battery module cooling structure including a battery module housing configured to accommodate therein the battery module, and a flow guide plate provided in the battery module housing, disposed at an outermost periphery of the battery module, and configured to guide a cooling liquid introduced into the battery module housing so that the cooling liquid flows between the plurality of battery cells.

### CROSS REFERENCE TO RELATED APPLICATIONS

This application claims priority to and the benefit of Korean Patent Application No. 10-2023-0134256 filed in the Korean Intellectual Property Office on Oct. 10, 2023, the entire contents of which are incorporated herein by reference.

### BACKGROUND

### (a) Field

The present disclosure relates to a battery module cooling structure, and more particularly, to a cooling liquid flow guide structure of an immersion cooling battery module, in which flow guide plates are added to upper and lower portions of the battery module to allow a cooling liquid to flow in the battery module.

### (b) Description of the Related Art

In general, a battery pack for an environmentally friendly vehicle includes battery modules made by assembling a plurality of battery cells. The battery pack finally mounted in the vehicle is manufactured by assembling a plurality of battery modules.

A pouch cell-based battery module broadly includes battery cells, surface pressure pads, endplates, sensing boards, and the like. The battery module requires advanced battery cell cooling technologies to meet the high specifications related to the high performance and fast charging performance of batteries. An immersion cooling technology, which is a direct cooling technology, may be considered to improve the cooling performance. The components used for the immersion cooling method include basic components of the battery module, a module housing, a cooling channel, and a cooling liquid (dielectric thermal fluid) for direct cooling.

However, in order to cool inner battery cells, cooling channels may be disposed between the battery cells, and direct cooling may be implemented by a flow of the cooling liquid. In the case of a general battery cell module, a sensing board is provided on a flow path through which the cooling liquid is introduced or discharged, and the presence of the sensing board hinders the flow of cooling liquid through the cooling channel between the battery cells, which may degrade the cooling efficiency.

### SUMMARY

The present disclosure attempts to provide a battery module cooling structure having flow guide plates disposed on upper and lower portions of a battery module to allow a cooling liquid to smoothly flow in the battery module, thereby improving cooling performance efficiency and structural stability.

An embodiment of the present disclosure provides a battery module cooling structure for a battery module configured by assembling a plurality of battery cells, the battery module cooling structure including a battery module housing configured to accommodate therein the battery module, and a flow guide plate provided in the battery module housing, disposed at an outermost periphery of the battery module, and configured to guide a cooling liquid introduced into the battery module housing so that the cooling liquid flows between the plurality of battery cells.

An inlet port, through which the cooling liquid is introduced into the battery module housing, may be provided at a position with a first height at one side of the battery module housing, and an outlet port, through which the cooling liquid is discharged to the outside of the battery module housing, may be provided at a position with a second height, which is different from the first height, at the other side of the battery module housing.

A pair of surface pressure pads configured to absorb a swell of the battery cell may be attached to outermost peripheries of the plurality of battery cells, and a pair of endplates configured to constitute the outermost periphery of the battery module may be attached between the surface pressure pads and the battery module housing.

The flow guide plate may include: a pair of flow guide support portions extending in a longitudinal direction of the battery cell and fixed to ends of the endplates; and a plurality of flow guide blade portions extending in a direction perpendicular to the longitudinal direction of the battery cell and integrally connected to the pair of flow guide support portions.

The battery module housing may include: an upper housing; and a lower housing, and the flow guide plate may include: a first flow guide plate disposed between the outermost periphery of the battery module and the upper housing; and a second flow guide plate disposed between the outermost periphery of the battery module and the lower housing.

The flow guide blade portions formed on the first and second flow guide plates may be inclined toward the outlet port and the inlet port, respectively.

The flow guide blade portion may be formed to have a height smaller than a height of the flow guide support portion.

The first flow guide blade portions formed on the first flow guide plate may have heights that gradually increase as the distance from the outlet port increases.

The first flow guide blade portions formed on the first flow guide plate may be formed at intervals that gradually decrease as the distance from the outlet port increases.

The second flow guide blade portions formed on the second flow guide plate may have heights that gradually increase as the distance from the inlet port increases.

The second flow guide blade portions formed on the second flow guide plate may be formed at intervals that gradually decrease as the distance from the inlet port increases.

The battery module cooling structure may further include: cooling liquid exit/entrance portions extending in the direction perpendicular to the longitudinal direction of the battery cell, disposed at outer peripheries of the flow guide blade portions positioned at outermost peripheries, and integrally connected to the pair of flow guide support portions.

The cooling liquid exit/entrance portion may be formed to have a height smaller than a height than the flow guide blade portion.

Maskings may be formed on some of the adjacent flow guide blade portions and block routes along which the cooling liquid flows between the plurality of battery cells.

According to the embodiment of the present disclosure, the flow guide plates are provided between the battery module housings and the battery cells, such that the cooling liquid may be introduced, flow, and be discharged along the optimal route between the battery cells, thereby maximizing the cooling performance efficiency.

In addition, the cooling control may be performed by changing the fluidity of the cooling liquid by deforming the flow guide plate structure.

In addition, the endplates at the two opposite ends of the battery module may be connected to the upper and lower flow guide plates to ensure the structural stability, and the surface pressure pads may be provided to apply surface pressure when the battery cell swells, which may contribute to ensuring the performance of the battery cell.

### BRIEF DESCRIPTION OF THE FIGURES

FIG. 1 is a perspective view illustrating a battery module cooling structure according to an embodiment of the present disclosure.

FIG. 2 is an exploded perspective view illustrating an interior of the battery module cooling structure according to the embodiment of the present disclosure.

FIG. 3 is a cross-sectional view illustrating a front surface of the battery module cooling structure according to the embodiment of the present disclosure.

FIG. 4 is a view schematically illustrating a flow of a cooling liquid at a lateral side of the battery module cooling structure according to the embodiment of the present disclosure.

FIG. 5 is a perspective view schematically illustrating a flow of the cooling liquid in the battery module cooling structure according to the embodiment of the present disclosure.

FIG. 6 is a partially cross-sectional view schematically illustrating a flow of the cooling liquid made by a first flow guide plate of the battery module cooling structure according to the embodiment of the present disclosure.

FIG. 7 is a partially cross-sectional view schematically illustrating a flow of the cooling liquid made by a second flow guide plate of the battery module cooling structure according to the embodiment of the present disclosure.

FIG. 8 is a perspective view illustrating the first flow guide plate of the battery module cooling structure according to the embodiment of the present disclosure.

FIG. 9 is a cross-sectional view taken along line ‘A-A’ in FIG. 8.

FIG. 10 is a cross-sectional view illustrating the second flow guide plate of the battery module cooling structure according to the embodiment of the present disclosure.

FIG. 11 is a perspective view illustrating a first flow guide plate according to another embodiment of the battery module cooling structure according to the embodiment of the present disclosure.

FIG. 12 is a perspective view illustrating a second flow guide plate according to another embodiment of the battery module cooling structure according to the embodiment of the present disclosure.

FIG. 13 is a cross-sectional view illustrating the first flow guide plate according to another embodiment of the battery module cooling structure according to the embodiment of the present disclosure.

FIG. 14 is a cross-sectional view illustrating the second flow guide plate according to another embodiment of the battery module cooling structure according to the embodiment of the present disclosure.

FIG. 15 is a view illustrating an example in which maskings are formed on the flow guide plate of the battery module cooling structure according to the embodiment of the present disclosure.

### DETAILED DESCRIPTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways and is not limited to the embodiments described herein.

In addition, the constituent elements having the same configurations in several embodiments will be assigned with the same reference numerals and described only in the representative embodiment, and only the constituent elements, which are different from the constituent elements according to the representative embodiment, will be described in other embodiments.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. Further, the same reference numerals designate the same structures, elements or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiment of the present disclosure specifically illustrates an example of the present disclosure. As a result, various modifications of the drawings are expected. Therefore, the embodiments are not limited to specific forms in regions illustrated in the drawings, and for example, include modifications of forms by the manufacture thereof.

Hereinafter, a battery module cooling structure according to an embodiment of the present disclosure will be described in detail with reference to the accompanying drawings.

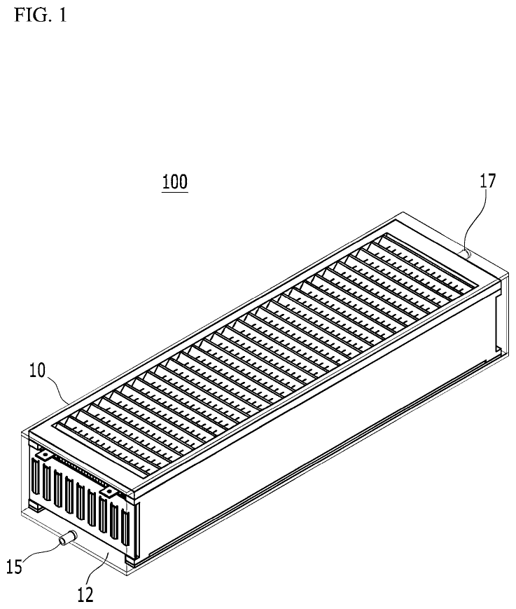

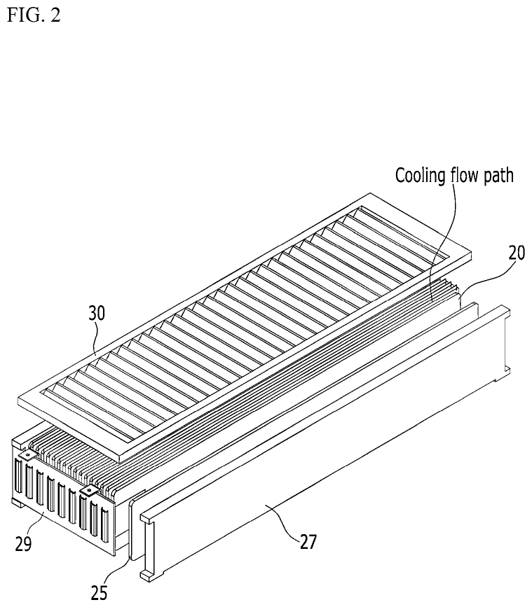

FIG. 1 is a perspective view illustrating a battery module cooling structure according to an embodiment of the present disclosure, and FIG. 2 is an exploded perspective view illustrating an interior of the battery module cooling structure according to the embodiment of the present disclosure.

With reference to FIGS. 1 and 2, a battery module cooling structure 100 according to an embodiment of the present disclosure is a structure for cooling a battery module configured by assembling a plurality of battery cells 20 and includes battery module housings 10 and 12 configured to accommodate therein the battery module, and flow guide plates 30 and 35 disposed in the battery module housings 10 and 12 and disposed at an outermost periphery of the battery module.

The battery module housings 10 and 12 include an upper housing 10 and a lower housing 12. A housing wall is formed at a lateral side to connect the upper housing 10 and the lower housing 12, thereby constituting the battery module housings 10 and 12 having a hexahedral shape as a whole.

An inlet port 15, through which a cooling liquid is introduced into the battery module housings 10 and 12, may be provided at a position with a first height at one side of the battery module housings 10 and 12, i.e., a position adjacent to the lower housing 12. An outlet port 17, through which the cooling liquid introduced into the battery module housings 10 and 12 is discharged to the outside of the battery module housings 10 and 12, may be provided at a position with a second height, which is different from the first height, at the other side of the battery module housings 10 and 12, i.e., a position adjacent to the upper housing 10.

The flow guide plates 30 and 35 may guide the cooling liquid so that the cooling liquid, which is introduced into the battery module housings 10 and 12 through the inlet port 15, flows between the plurality of battery cells 20 and is smoothly discharged to the outside of the battery module housings 10 and 12 through the outlet port 17.

The flow guide plates 30 and 35 may include a first flow guide plate 30 disposed between the outermost periphery of the battery module and the upper housing 10, and a second flow guide plate 35 disposed between the outermost periphery of the battery module and the lower housing 12. The flow of the cooling liquid, which is introduced through the inlet port 15, may be guided between a plurality of battery cells 20 through the second flow guide plate 35. The flow of the cooling liquid having passed between the plurality of battery cells 20 may be guided to the outlet port 17 through the first flow guide plate 30.

Meanwhile, a pair of surface pressure pads 25, which absorbs a swell of the battery cell 20, may be attached to outermost peripheries of the plurality of battery cells 20. In addition, a pair of endplates 27, which constitutes the outermost periphery of the battery module, is attached between the surface pressure pads 25 and the battery module housings 10 and 12, and a sensing board 29 may be provided at one end of the battery cells 20.

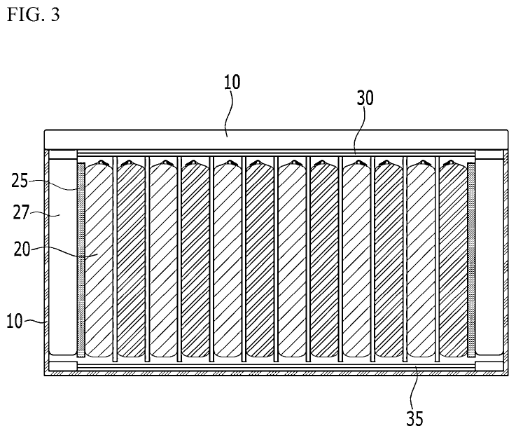

FIG. 3 is a cross-sectional view illustrating a front surface of the battery module cooling structure according to the embodiment of the present disclosure.

With reference to FIG. 3, the battery module configured by assembling the plurality of battery cells 20 may be disposed in the battery module housings 10 and 12, and the surface pressure pads 25 and the endplates 27 may be sequentially attached to the outermost peripheries of the plurality of battery cells 20.

The flow guide plates 30 and 35 may be disposed between the battery cells 20 and the battery module housings 10 and 12 and fixed to ends of the endplates 27. The flow guide plates 30 and 35 may include the first flow guide plate 30 adjacent to the upper housing 10, and the second flow guide plate 35 adjacent to the lower housing 12.

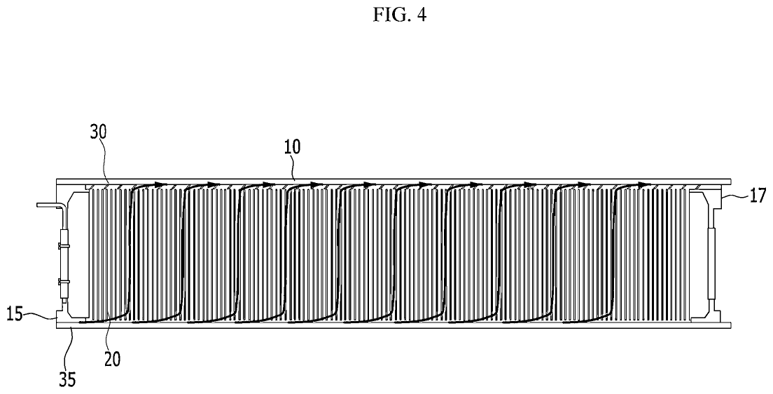

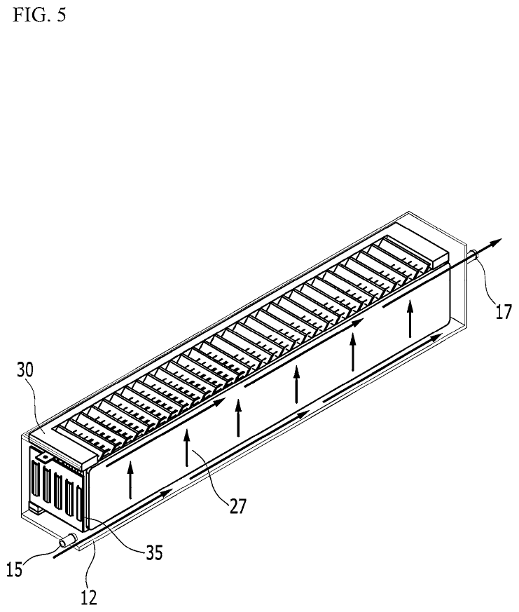

FIG. 4 is a view schematically illustrating a flow of the cooling liquid at a lateral side of the battery module cooling structure according to the embodiment of the present disclosure, and FIG. 5 is a perspective view schematically illustrating a flow of the cooling liquid in the battery module cooling structure according to the embodiment of the present disclosure.

With reference to FIGS. 4 and 5, the first flow guide plate 30 is disposed between an upper portion of the battery module and the upper housing 10, and the second flow guide plate 35 is disposed between a lower portion of the battery module and the lower housing 12.

The inlet port 15 is disposed adjacent to the second flow guide plate 35 and provided at the position with the first height at one side of the battery module housings 10 and 12. The flow of the cooling liquid, which is introduced into the battery module through the inlet port 15, is guided between the battery cells 20 by the second flow guide plate 35.

The outlet port 17 is disposed adjacent to the first flow guide plate 30 and provided at the position with the second height at the other side of the battery module housings 10 and 12. The second height may be larger than the first height. The cooling liquid, which flows between the battery cells 20, is discharged to the outlet port 17 by the first flow guide plate 30.

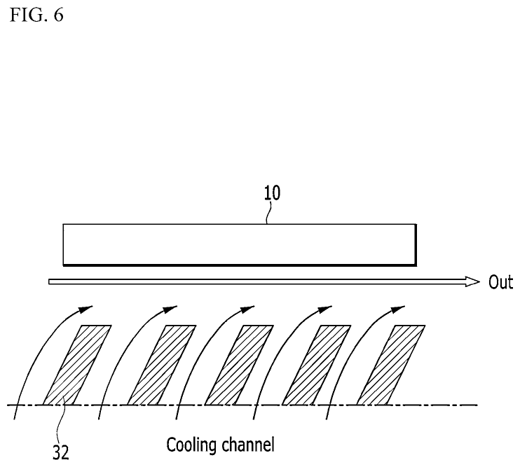

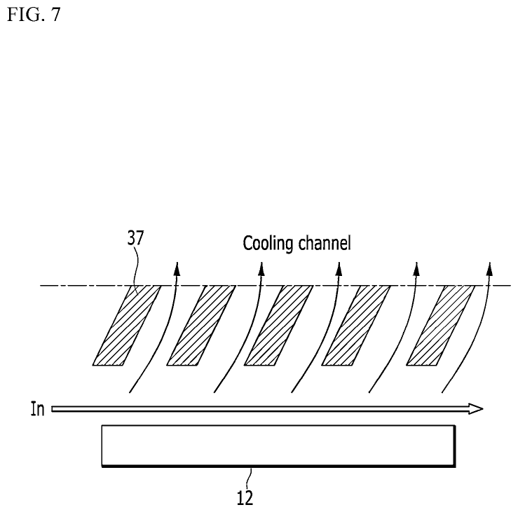

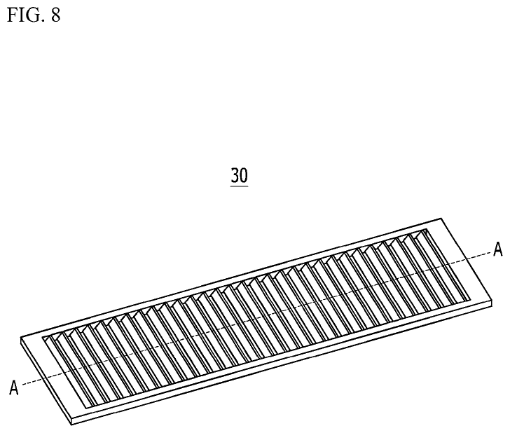

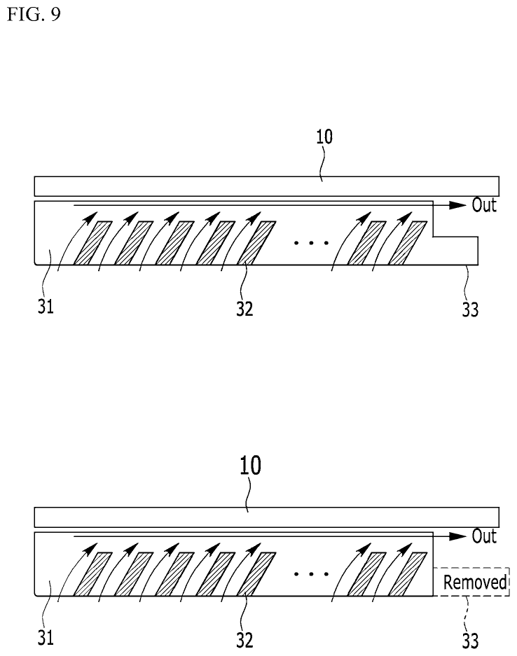

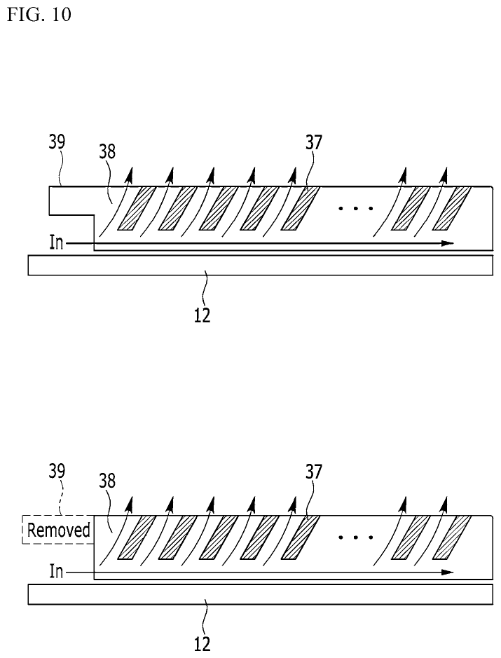

FIG. 6 is a partially cross-sectional view schematically illustrating a flow of the cooling liquid made by a first flow guide plate of the battery module cooling structure according to the embodiment of the present disclosure, FIG. 7 is a partially cross-sectional view schematically illustrating a flow of the cooling liquid made by a second flow guide plate of the battery module cooling structure according to the embodiment of the present disclosure, FIG. 8 is a perspective view illustrating the first flow guide plate of the battery module cooling structure according to the embodiment of the present disclosure, FIG. 9 is a cross-sectional view taken along line ‘A-A’ in FIG. 8, and FIG. 10 is a cross-sectional view illustrating the second flow guide plate of the battery module cooling structure according to the embodiment of the present disclosure.

With reference to FIGS. 6 to 10, in the battery module cooling structure according to the embodiment of the present disclosure, the flow guide plates 30 and 35 according to the embodiment may include a pair of flow guide support portions 31 and 38 extending in a longitudinal direction of the battery cell 20 and fixed to the ends of the endplates 27, and a plurality of flow guide blade portions 32 and 37 extending in a direction perpendicular to the longitudinal direction of the battery cell 20 and integrally connected to the pair of flow guide support portions 31 and 38.

As illustrated in FIGS. 6 and 9, the first flow guide plate 30 may include the flow guide support portion 31 and the plurality of flow guide blade portions 32 integrally connected to the flow guide support portion 31, and the plurality of flow guide blade portions 32 may be inclined toward the outlet port 17. The cooling liquid, which flows between the plurality of battery cells 20, may be guided by the inclined flow guide blade portions 32 and flow toward the outlet port 17.

The flow guide blade portion 32 may be formed to have a height smaller than a height of the flow guide support portion 31. Therefore, spaces, in which the cooling liquid may flow, may be ensured between the upper housing 10 and the flow guide blade portions 32.

Meanwhile, a cooling liquid exit/entrance portion 33 may be further provided at an outer periphery of the flow guide blade portion 32 positioned at the outermost periphery and integrally connected to the flow guide support portion 31. The cooling liquid exit/entrance portion 33 may guide the cooling liquid, which has passed over the flow guide blade portion 32 at the outermost periphery, so that the cooling liquid may smoothly flow toward the outlet port 17. The cooling liquid exit/entrance portion may be formed to have a height smaller than the height of the flow guide blade portion 32.

Meanwhile, the cooling liquid exit/entrance portion 33 may be removed, as necessary, to adjust the amount of cooling liquid to be discharged.

With reference to FIGS. 7 and 10, the second flow guide plate 35 may include the flow guide support portion 38 and the plurality of flow guide blade portions 37 integrally connected to the flow guide support portion 38, and the plurality of flow guide blade portions 37 may be inclined toward the inlet port 15. The cooling liquid, which is introduced into the battery module through the inlet port 15, may be guided by the inclined flow guide blade portions 37 and flow between the plurality of battery cells 20.

The flow guide blade portion 37 may be formed to have a height smaller than a height of the flow guide support portion 38. Therefore, spaces, in which the cooling liquid may flow, may be ensured between the lower housing 12 and the flow guide blade portions 37.

A cooling liquid exit/entrance portion 39 may be further provided at an outer periphery of the flow guide blade portion 37 positioned at the outermost periphery and integrally connected to the flow guide support portion 38. The cooling liquid exit/entrance portion 39 may guide the cooling liquid, which is introduced through the inlet port 15, so that the cooling liquid may smoothly flow toward the flow guide blade portion 37. The cooling liquid exit/entrance portion 39 may be formed to have a height smaller than the height of the flow guide blade portion 37.

Like the cooling liquid exit/entrance portion formed at a side of the outlet port 17, the cooling liquid exit/entrance portion 39 may be removed, as necessary, to adjust the amount of cooling liquid to be introduced through the inlet port 15.

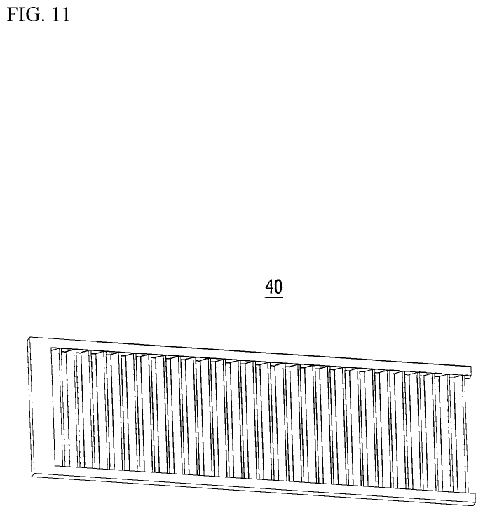

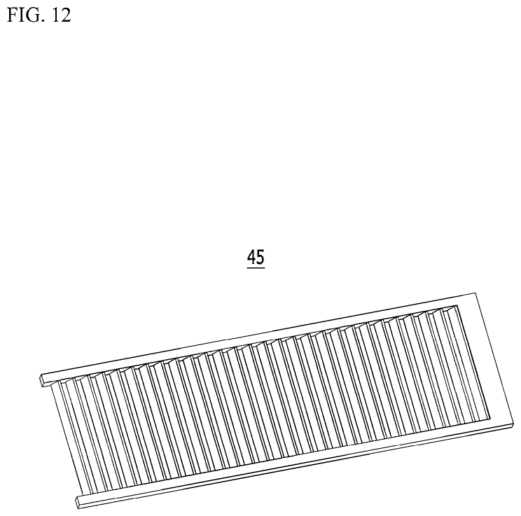

FIG. 11 is a perspective view illustrating a first flow guide plate according to another embodiment of the battery module cooling structure according to the embodiment of the present disclosure, and FIG. 12 is a perspective view illustrating a second flow guide plate according to another embodiment of the battery module cooling structure according to the embodiment of the present disclosure.

As illustrated in FIG. 11, a first flow guide plate 40 may include a flow guide support portion and a plurality of flow guide blade portions integrally connected to the flow guide support portion and have a structure in which a cooling liquid exit/entrance portion at a side of the flow guide blade portion at the outermost periphery at the side of the outlet port 17 may be excluded.

In addition, as illustrated in FIG. 12, a second flow guide plate 45 may include a flow guide support portion and a plurality of flow guide blade portions integrally connected to the flow guide support portion and have a structure in which a cooling liquid exit/entrance portion at a side of the flow guide blade portion at the outermost periphery at the side of the inlet port 15 may be excluded.

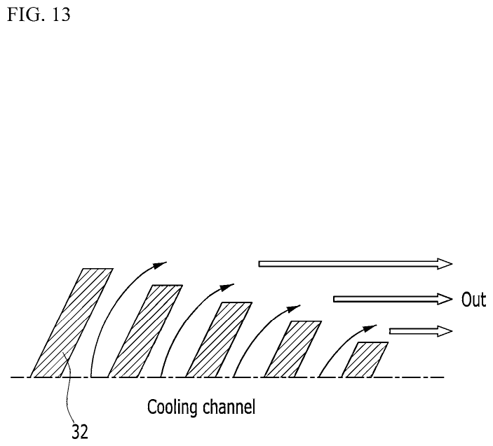

FIG. 13 is a cross-sectional view illustrating the first flow guide plate according to another embodiment of the battery module cooling structure according to the embodiment of the present disclosure.

As illustrated in FIG. 13, the first flow guide blade portions 32 formed on the first flow guide plate 30 may have heights that gradually increase as the distance from the outlet port 17 increases. In addition, the first flow guide blade portions 32 may be formed at intervals that gradually decrease as the distance from the outlet port 17 increases.

Because the heights of the first flow guide blade portions 32 increase and the intervals between the first flow guide blade portions 32 decrease as the distance from the outlet port 17 increases, a flow velocity of the cooling liquid may be high at a point distant from the outlet port 17. That is, the cooling liquid may smoothly flow without slowing down even at the point distant from the outlet port 17, such that the cooling liquid may smoothly flow over the entire first flow guide plate 30.

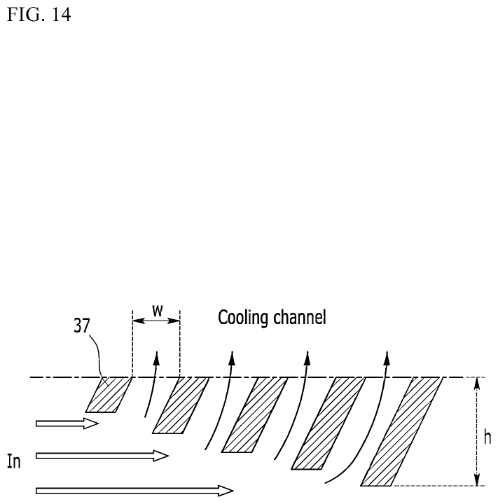

FIG. 14 is a cross-sectional view illustrating the second flow guide plate according to another embodiment of the battery module cooling structure according to the embodiment of the present disclosure.

As illustrated in FIG. 14, the second flow guide blade portions 37 of the second flow guide plate 35 may have heights h that gradually increase as the distance from the inlet port 15 increases, and intervals w between the second flow guide blade portions 37 may gradually decrease as the distance from the inlet port 15 increases.

Because the heights of the second flow guide blade portions 37 increase and the intervals between the second flow guide blade portions 37 decrease as the distance from the inlet port 15 increases, a flow velocity of the cooling liquid may be high at a point distant from the inlet port 15. That is, the cooling liquid may smoothly flow without slowing down even at the point distant from the inlet port 15, such that the cooling liquid may smoothly flow over the entire second flow guide plate 35.

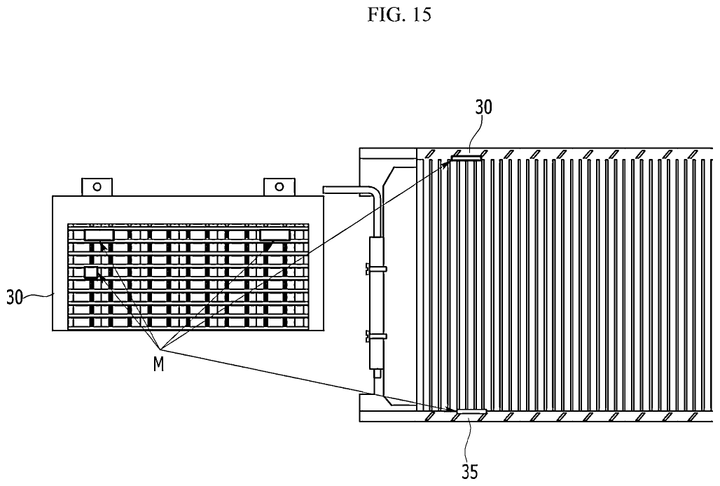

FIG. 15 is a view illustrating an example in which maskings are formed on the flow guide plate of the battery module cooling structure according to the embodiment of the present disclosure.

As illustrated in FIG. 15, maskings M may be formed on a portion between the adjacent flow guide blade portions. As necessary, the masking M may be provided at a portion of the battery cell 20 where the flow of the cooling liquid is intended to be blocked. The masking M may be variously provided between the flow guide blade portions of the first flow guide plate 30 and/or the second flow guide plate 35.

According to the embodiment of the present disclosure described above, the flow guide plates are provided between the battery module housings and the battery cells, such that the cooling liquid may be introduced, flow, and be discharged along the optimal route between the battery cells, thereby maximizing the cooling performance efficiency.

In addition, the cooling control may be performed by changing the fluidity of the cooling liquid by deforming the flow guide plate structure.

In addition, the endplates at the two opposite ends of the battery module may be connected to the upper and lower flow guide plates to ensure the structural stability, and the surface pressure pads may be provided to apply surface pressure when the battery cell swells, which may contribute to ensuring the performance of the battery cell.

While the exemplary embodiments of the present disclosure have been described, the present disclosure is not limited to the embodiments. The present disclosure covers all modifications that can be easily made from the embodiments of the present disclosure by those skilled in the art and considered as being equivalent to the present disclosure.

1. A battery module cooling structure for a battery module configured by assembling a plurality of battery cells, the battery module cooling structure comprising:
a battery module housing configured to accommodate the battery module; and
a flow guide plate positioned in the battery module housing, disposed at an outermost periphery of the battery module, and configured to guide a cooling liquid introduced into the battery module housing so that the cooling liquid flows between the plurality of battery cells.

2. The battery module cooling structure of claim 1, wherein:
an inlet port, through which the cooling liquid is introduced into the battery module housing, is provided at a position with a first height at one side of the battery module housing; and
an outlet port, through which the cooling liquid is discharged to the outside of the battery module housing, is provided at a position with a second height, which is different from the first height, at an other side of the battery module housing.

3. The battery module cooling structure of claim 1, wherein:
a pair of surface pressure pads configured to absorb a swell of the battery cell are attached to outermost peripheries of each of the plurality of battery cells; and
a pair of endplates configured to constitute the outermost periphery of the battery module is attached between each of the surface pressure pads and the battery module housing.

4. The battery module cooling structure of claim 3, wherein
the flow guide plate comprises:
a pair of flow guide support portions extending in a longitudinal direction of the battery cell and fixed to ends of each of the endplates; and
a plurality of flow guide blade portions extending in a direction perpendicular to the longitudinal direction of the battery cell and integrally connected to the pair of flow guide support portions.

5. The battery module cooling structure of claim 2, wherein
the battery module housing comprises
an upper housing and
a lower housing, and
wherein the flow guide plate comprises
a first flow guide plate positioned between the outermost periphery of the battery module and the upper housing, and
a second flow guide plate positioned between the outermost periphery of the battery module and the lower housing.

6. The battery module cooling structure of claim 5, wherein
the first flow guide plate includes a first plurality of flow guide blade portions inclined toward the outlet port, and wherein the second flow guide plate includes a second plurality of flow guide blade portions inclined toward the inlet port.

7. The battery module cooling structure of claim 4, wherein each of
the flow guide blade portions has a height smaller than a height of the each of the flow guide support portions.

8. The battery module cooling structure of claim 6, wherein
each of the first flow guide blade portions formed on the first flow guide plate has a height that gradually increases as a distance from the outlet port increases.

9. The battery module cooling structure of claim 6, wherein
each of the first flow guide blade portions formed on the first flow guide plate are formed at intervals that gradually decrease as a distance from the outlet port increases.

10. The battery module cooling structure of claim 6, wherein
each of the second flow guide blade portions formed on the second flow guide plate has a height that gradually increases as a distance from the inlet port increases.

11. The battery module cooling structure of claim 6, wherein
each of the second flow guide blade portions formed on the second flow guide plate are formed at intervals that gradually decrease as a distance from the inlet port increases.

12. The battery module cooling structure of claim 4, further comprising:
cooling liquid exit and entrance portions extending in the direction perpendicular to the longitudinal direction of the battery cell, and positioned at outer peripheries of the plurality of flow guide blade portions positioned at outermost peripheries, and integrally connected to the pair of flow guide support portions.

13. The battery module cooling structure of claim 12, wherein:
the cooling liquid exit and entrance portions have a height smaller than a height of the plurality of flow guide blade portions.

14. The battery module cooling structure of claim 4, wherein:
maskings are formed on some of the adjacent flow guide blade portions, the masking being configured to block routes along which the cooling liquid flows between the plurality of battery cells.
